(19) United States
(12) Patent Application Publication
(10) Pub. No.: US 2002/0094830 A1
(43) Pub. Date: Jul. 18, 2002

(54) Method of transmitting data signals

(76) Inventors: Dirk Wenzel, Hamburg (DE); Wolfgang Tobergte, Halstenbek (DE)

Correspondence Address: U.S. Philips Corporation, 580 White Plains Road, Tarrytown, NY, 10591, US

(21) Appl. No.: 10/047,029

(22) Filed: Jan. 15, 2002

(30) Foreign Application Priority Data
Jan. 16, 2001 (DE) 10101918.1

(51) Int. Cl. H04B 7/00

(52) U.S. Cl. 455/517; 455/509

(57) ABSTRACT

A method of transmitting data signals between a base station and a plurality of moving data media is described, in which, for the purpose of starting a data transmission, the base station emits a command signal in response to which data media, which receive this command signal, each send a response signal to the base station, whereupon the base station selects one of the data media for data transmission, and the transmission of data from the data medium to the base station is triggered solely in this selected data medium.

According to the invention, in such a method a select code is appended to the signals which are sent by the base station solely for a selected data medium (i.e. transponder), by means of which select code these signals are marked as sent by the base station solely for a selected data medium, and the emission of data signals to the base station upon the reception of a data signal sent by the base station and comprising a select code is suppressed independently of the remaining content of this data signal sent by the base station in all data media not previously selected by the base station for data transmission.

In systems with moving transponders, the invention ensures in a simple way an unambiguous distinction between data signals that are to be transmitted solely to a selected transponder and data signals which are also intended for non-selected transponders. It permits a reliable data transmission and therefore a reduction of the error rate. This is achieved both for systems with encrypted data transmission to the transponder and with non-encrypted data transmission. The respective encryption method applied is not affected thereby.

The invention relates to a method of transmitting data signals between a base station and a plurality of moving data media in which, for the purpose of starting a data transmission, the base station emits a command signal in response to which data media, which receive this command signal, each send a response signal to the base station, whereupon the base station selects one of the data media for data transmission, and the transmission of data from the data medium to the base station is triggered solely in this selected data medium.

Moving data media of the type designated above, also termed “transponders” below and preferably configured for contactless data exchange with the base station, also denoted as “reader” , are generally used for identification or as data memories on moving parts. Examples of such data media are, in particular, contactless chip cards in access control systems, devices for immobilization in a motor vehicle key, electronic luggage marks (“luggage tags”) for automatically distributing and sorting pieces of luggage in luggage traffic, for example at airports, and electronic memories for sorting and tracking during package transport.

All of these applications have a base station which exchanges data with the transponders. The present invention particularly relates to systems which comprise a base station and a plurality of moving data media, with only one transmission channel (for example, an ISM frequency), in which systems a plurality of transponders can be located simultaneously in the reading range of the base station, that is to say, in particular in its signaling range. Transponders are added anew or leave the reading range to the extent to which they are spatially moved, for example, with the pieces of luggage to which they are fastened during the envisaged transportation.

In order to ensure viable data exchange between the base station and the transponder in such systems, data transmission methods are applied in which the base station sends the command signal mentioned hereinbefore, and the transponder responds to this command signal with the response signal mentioned hereinbefore (which are termed “Reader-Talks-First-Systems”). The transponders can be selected individually one after another by means of what is termed an anti-collision command by means of what is termed an anti-collision method with the aid of which the response signals of the transponders are subsequently evaluated in the base station. Accordingly, data signals can be written from the base station solely to the transponder selected by the anti-collision command, that is to say, transmitted, or they can be read by said transponder. In this case, all the other, non-selected transponders must ignore the data signals which are being or have been transmitted from the base station to the selected transponder, and ignore the commands included therein for the selected transponder.

It has been found that two problems arise in executing this data transmission method.

First, let it be assumed that the base station exchanges data signals with a selected first transponder. If a non-selected second transponder enters the reading range—for example is brought into the zone of action of a magnetic field emitted by the base station for the purpose of sending the data signals—precisely during the time when the data signals (with commands included therein solely for the selected first transponder) are transmitted to the selected first transponder, this selected first transponder receives only the last part of the data signal from the base station and thus also only the last part of the data or commands to be transmitted with this data signal from the base station to the selected first transponder. If this data signal (also termed “data fragment”) mutilated during reception by the non-selected second transponder in the case of this second transponder corresponds at random to an “anticollision command” from the execution of the above-mentioned anti-collision method, the non-selected second transponder will likewise respond, that is to say, it will dispatch a response signal to the base station although the latter is expecting such a response signal only from the selected first transponder. The superimposed response signals of the two transponders (the selected first and the non-selected second ones) cannot be distinguished in the receiver of the base station and therefore lead to data errors.

A further problem arises when the data exchange is encrypted with the selected first transponder. The encryption of the commands of the base station is therefore mapped onto arbitrary data. In this case, an encrypted command cannot be excluded from corresponding to an “anti-collision command”. Consequently, both the selected first transponder and the non-selected second one—and, moreover, also all the other transponders which are currently located in the reading range of the base station—respond simultaneously. This superimposition of the response signals also leads to data errors.

It is an object of the invention to obviate the outlined problems by a simple design of the above-described method of exchanging data between the base station and transponders.

According to the invention, this object is achieved in a method of the type mentioned in the opening paragraph in that a select code is appended to the signals which are sent by the base station solely for a selected data medium (i.e. transponder), by means of which select code these signals are marked as sent by the base station solely for a selected data medium, and wherein the emission of data signals to the base station upon the reception of a data signal sent by the base station and comprising a select code is suppressed independently of the remaining content of this data signal sent by the base station in all data media not previously selected by the base station for data transmission.

In a preferred embodiment of the method according to the invention, the select code is transmitted in a non-encrypted fashion in the data signal sent by the base station, specifically even when the remaining constituents of the data signal are encrypted.

In a further development of the method according to the invention, the select code is formed by a single bit (select code bit) in the data signal sent by the base station.

In an advantageous development of the method according to the invention, the select code assumes a first value in the data signal sent by the base station when the data signal is marked as sent by the base station solely for a selected data medium, and wherein the select code assumes a second value in the data signal sent by the base station when the data signal is marked as sent by the base station for all data media.

An embodiment is illustrated in the drawing and explained in more detail below. In the drawing:

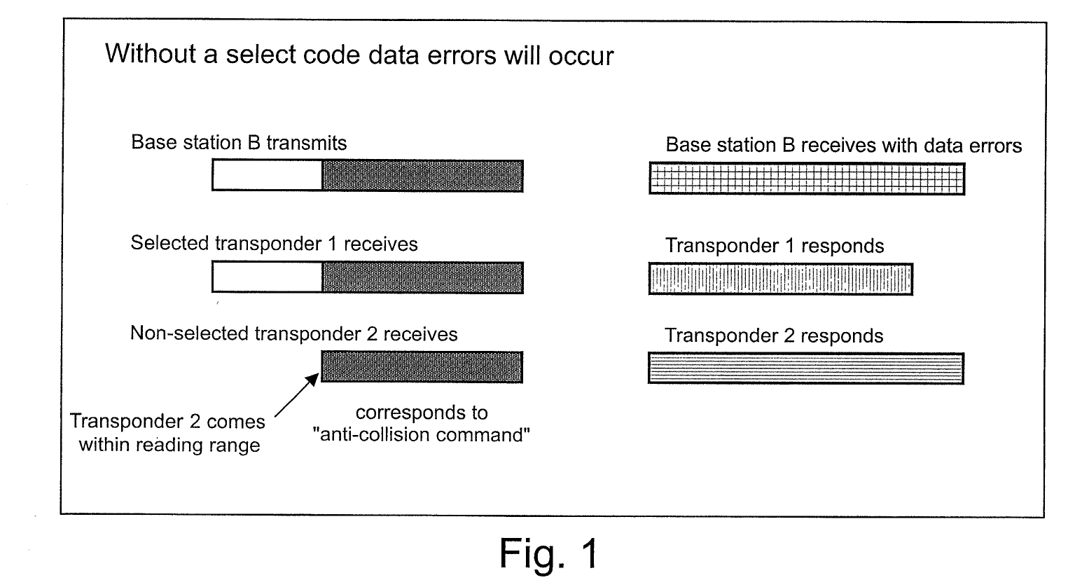

FIG. 1 shows schematically an example of a signal profile of data signals exchanged between base station and transponders in the method without applying a select code, and

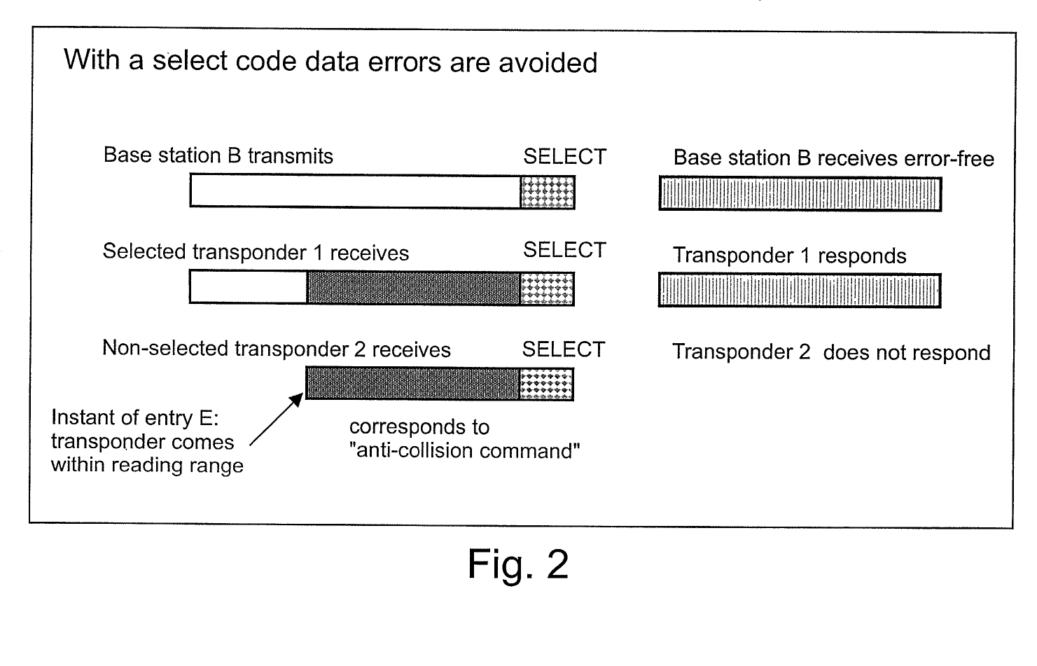

FIG. 2 shows schematically an example of a signal profile of data signals exchanged between base station and transponders in the method with a select code.

Illustrated along a time axis running horizontally in FIGS. 1 and 2 is the temporal sequence of a data signal, emitted by the base station B, in the first row of each Figure, and of one or two data signal or signals sent back by a selected transponder 1 or a non-selected transponder 2, respectively—in the second and third rows of each Figure.

In accordance with the configuration of the signals illustrated in the Figures, the base station B emits a data signal which is received by a first transponder 1, selected with this or a preceding, non-illustrated data signal, in its entire length, but is received, by contrast, only in a mutilated fashion by a second, non-selected transponder 2. It is assumed in the illustrative example of the Figures that the non-selected second transponder receives only the concluding part of the data signal, which begins at the instant of entry E, for example, because it is transported into the reading range of the base station B precisely at this instant of entry E during the time interval within which the transmission of the data signal from the base station B to the selected first transponder 1 is carried out.

It is further assumed for the illustration of the embodiment that the concluding part of the data signal, which begins at the instant of entry E, corresponds precisely to the “anti-collision command” of the base station B. In this case, in accordance with the example of the signal profile illustrated in FIG. 1, both the selected first transponder 1 and the nonselected second transponder 2 respond, that is to say, each send back a data signal to the base station B, as illustrated in FIG. 1. The base station B receives the superimposed data signals from the transponders 1 and 2 with data errors, since they cannot separate the data signals.

The present invention solves the above described problems in a simple way, as may be recognized in FIG. 2 from the example of the signal profile illustrated there. For this purpose, a select code SELECT is appended to the data in the data signal, which is intended to be emitted by the base station B, which select code may be, for example, only one bit long and marks whether the command emitted with the relevant data signal by the base station B is valid for the selected first transponder 1, or also for all other, non-selected transponders, for example for the non-selected second transponder 2. This select code is always at the end of a data transmission, that is to say, it is a signal, from the base station B to the transponder, and is not encrypted. A transponder can therefore reliably recognize from the select code whether a data signal or a command for a selected transponder is concerned. The last part of a command, or an encrypted command is therefore also always distinguished from an “anti-collision command” of the base station B.

If such a data signal provided with the select code is emitted by the base station B, or if the base station B emits a data signal in which the select code is set to the value by which this data signal is marked as being sent exclusively by the base station B for a selected data medium, and if this data signal is received by both the selected first transponder 1 and by the non-selected second transponder 2, both transponders 1, 2 recognize that this data signal or command is intended exclusively for a transponder which has already been selected. Since the second transponder 2 is in the non-selected state, it will ignore the received data signal or command, even if it were, for example, to recognize its content falsely as “anti-collision command” to which it could and also would have to respond if the select code (or the value which the select code assumes) did not suppress this.

It is thereby ensured that only the selected first transponder 1 responds, whereas the non-selected second transponder 2 does so in no case. The base station B can therefore receive without error the data signal transmitted to it as response from the selected first transponder 1, because the non-selected second transponder 2 does not respond.

In systems with moving transponders, the present invention therefore ensures in a simple way an unambiguous distinction between data signals that are to be transmitted solely to a selected transponder and data signals which are also intended for non-selected transponders. It thus permits a reliable data transmission and therefore a reduction of the error rate. This is achieved both for systems with encrypted data transmission to the transponder and with non-encrypted data transmission. The respective encryption method applied is not affected thereby.

1. A method of transmitting data signals between a base station (B) and a plurality of moving data media (1, 2) in which, for the purpose of starting a data transmission, the base station (B) emits a command signal in response to which data media (1, 2), which receive this command signal, each send a response signal to the base station (B), whereupon the base station (B) selects one (1) of the data media (1, 2) for data transmission, and the transmission of data from the data medium (1) to the base station (B) is triggered solely in this selected data medium (1), wherein a select code (SELECT) is appended to the signals which are sent by the base station (B) solely for a selected data medium (1), by means of which select code these signals are marked as sent by the base station (B) solely for a selected data medium (1), and wherein the emission of data signals to the base station (B) upon the reception of a data signal sent by the base station (B) and comprising a select code (SELECT) is suppressed independently of the remaining content of this data signal sent by the base station (B) in all data media (2) not previously selected by the base station (B) for data transmission.

2. The method as claimed in claim 1, wherein the select code (SELECT) is transmitted in a non-encrypted fashion in the data signal sent by the base station (B).

3. The method as claimed in claim 1 or 2, wherein the select code (SELECT) is formed by a single bit (select code bit) in the data signal sent by the base station (B).

4. The method as claimed in claim 1,2 or 3, wherein the select code (SELECT) assumes a first value in the data signal sent by the base station (B) when the data signal is marked as sent by the base station (B) solely for a selected data medium (1), and wherein the select code (SELECT) assumes a second value in the data signal sent by the base station (B) when the data signal is marked as sent by the base station (B) for all data media (1, 2).
